(19) United States
(12) Patent Application Publication
(10) Pub. No.: US 2008/0000710 A1
(43) Pub. Date: Jan. 3, 2008

(54) Switchable Stabilizer for a Motor Vehicle

(76) Inventors: Jens Vortmeyer, Preussisch Oldendorf (DE); Andreas Hartmann, Hoeltinghausen (DE); Bernd Grannemann, Espelkamp (DE); Mauro Zanella, Dielingen (DE); Stefan Beetz, Barnin (DE); Torsten Baustian, Crivitz (DE); Gerald Festner, Klein Krams (DE)

Correspondence Address: MCGLEW & TUTTLE, PC, P.O. BOX 9227, SCARBOROUGH STATION, SCARBOROUGH, NY, 10510-9227, US

(21) Appl. No.: 11/576,319

(22) PCT Filed: Sep. 28, 2005
(86) PCT No.: PCT/DE05/01724

§ 371 Date: Sep. 5, 2007

(30) Foreign Application Priority Data
Sep. 30, 2004 (DE) 10 2004 048 085.0

(51) Int. Cl. B60W 30/02

(52) U.S. Cl. 180/282

(57) ABSTRACT

A switchable stabilizer is provided as a compact assembly unit. The hydraulic system of the hydraulic and control part (9) may form a closed circuit with the piston-and-cylinder unit of the switchable coupling unit (3)and the hydraulic and control part (9) may be integrated in the cylindrical housing (10) of the switchable coupling (3).

### CROSS REFERENCE TO RELATED APPLICATIONS

This application is a United States National Phase application of International Application PCT/DE2005/001724 and claims the benefit of priority under 35 U.S.C. § 119 of German Patent Application DE 10 2004 048 085.0 filed Sep. 30, 2004, the entire contents of which are incorporated herein by reference.

### FIELD OF THE INVENTION

The present invention pertains to a switchable stabilizer for a motor vehicle, comprising a first stabilizer part and a second stabilizer part, the two being connected to one another via a switchable coupling, wherein the switchable coupling is designed as a single-acting piston-and-cylinder unit and is connected to a hydraulic and control part. Such stabilizers are used in automotive engineering.

### BACKGROUND OF THE INVENTION

A stabilizer, which operates according to the principle of the torsion bar, is arranged in parallel to the axle of the vehicle and is fastened to a wheel suspension at both ends, is associated, in principle, with each axle of a motor vehicle. This stabilizer prevents or substantially weakens the transmission of rolling motions caused by the road conditions and originating from the wheels to the vehicle body. Such rolling motions occur especially in road curves or under uneven road conditions.

One-part stabilizers are dimensioned and their material properties are selected for a predetermined spring rate, so that they can absorb torsional forces of a certain order of magnitude only and can generate corresponding opposing forces. However, they thus respond to different loads either too softly or too harshly, which has an unfavorable effect on driving smoothness. One-part stabilizers are therefore very well suited for use on the road. By contrast, they are not suitable for vehicles that are designed for off-road use because of the higher torsional loads.

Two-part stabilizers, which are connected to one another via a switchable coupling, are therefore used in case of higher torsional loads, as they occur, for example, during such off-road travel and where the limited torsion angle of a one-part stabilizer is no longer sufficient.

Such a switchable coupling is described in DE 199 23 100 C1. This switchable coupling comprises an outer rotary part and an inner rotary part, which are connected rigidly to one stabilizer part, on the one hand, and to the other stabilizer part, on the other hand. The outer rotary part and the inner rotary part are equipped with two opposite toothed elements, which are arranged on a common radial plane and which form two opposite free spaces between them. Furthermore, an axially displaceable locking piston, which has locking elements fitting the spaces of the toothed elements on the front side and which is loaded by a compression spring in the locking direction and by a hydraulic pressure in the unlocking direction, is guided in the coupling. A corresponding hydraulic system, which comprises mainly a pump, a switchable directional control valve, a tank and a pressure reservoir and is designed as a compact unit, is provided to build up the necessary hydraulic pressure. This compact hydraulic unit is arranged in a moisture-protected space of the vehicle and is connected to the coupling of the two-part stabilizer via overhead lines.

For travel, e.g., on the road, the hydraulic pressure in the hydraulic coupling is switched off, so that the locking piston is displaced under the force of the compression spring and it fills the free spaces between the toothed elements of the two rotary parts with its locking elements without clearance. The two parts of the stabilizer are thus connected to one another in such a way that they rotate in unison and the two stabilizer parts thus behave in this position as a one-part stabilizer. For travel, e.g., off the road, the locking piston is loaded by a hydraulic pressure, which displaces the locking piston against the force of the compression spring and thus opens the locking elements and the radial toothed elements. The outer rotary part and the inner rotary part and hence both stabilizer parts are rotatable in relation to one another by a limited torsion angle in this open position.

This switchable stabilizer meets all the necessary technical requirements. However, drawbacks arise in the area of manufacture and maintenance. Thus, the two stabilizer parts, the electric control parts and the hydraulic components must be manufactured separately and then completed on an assembly line and installed in the vehicle. The necessary testing of the system and the function is then carried out in the installed state. If a defect is detected, the defective component must be removed from the vehicle and replaced with a new component.

### SUMMARY OF THE INVENTION

The basic object of the present invention is to further improve the reliability of a stabilizer designed according to this class to function especially in respect to its switching behavior.

This object is accomplished by a switchable stabilizer according to the invention. According to the present invention a switchable stabilizer comprises a first stabilizer part, a second stabilizer part a switchable coupling and a hydraulic and control part with a hydraulic system. The first stabilizer part and the second stabilizer part are connected to one another via the switchable coupling. The switchable coupling is designed as a single-acting piston-and-cylinder unit and is connected to the hydraulic system. The hydraulic and control part forms a closed circuit with the piston-and-cylinder unit of the switchable coupling unit in a switchable stabilizer. Furthermore, according to another aspect of the invention, the hydraulic and control part is integrated in the cylindrical housing of the switchable coupling in the switchable stabilizer.

The special advantage of these solutions is that it becomes unnecessary to place the hydraulic system at a site protected from moisture due to the introduction of a hydraulic system with a closed hydraulic circuit. Closed hydraulic circuits have no connection to the atmosphere, and the hydraulic system can thus also be arranged in the underbody area of the vehicle. This makes it possible to design the two-part stabilizer with its switchable coupling and with the hydraulic system as a compact assembly unit. This leads to considerable advantages in terms of costs in the area of manufacture and system testing because the compact device can be processed separately.

Cost savings also arise from the fact that the hydraulic lines from the hydraulic system to the stabilizer, which are otherwise necessary, can be eliminated.

Spaces needed for installation are also saved on the vehicles where the hydraulic lines are otherwise located and where the hydraulic and control part was placed. It also becomes unnecessary to keep free the space needed for the installation of the hydraulic and control part on vehicles for which no switchable stabilizer was provided at all.

In an advantageous embodiment of a stabilizer according to claim 1, the hydraulic and control part is connected to the coupling pressure space of the switchable coupling via a delivery line and to the coupling spring space of the switchable coupling via a suction line. Furthermore, the delivery line is connected to an electric manometric switch and the suction line to a pressure reservoir, and the delivery line and the suction line are in connection via a bridge line, wherein an electromagnetically switchable 2/2-way valve, which is closed in the energized position and open in the non-energized position, is arranged in the bridge line.

According to an advantageous variant of a stabilizer according to claim 3, the hydraulic and control part is directed coaxially to the switchable coupling and comprises a cylindrical housing and a valve block arranged in the cylindrical housing, wherein the cylindrical housing of the hydraulic and control part is connected to the cylindrical housing of the switchable coupling in such a way that they rotate in unison and the valve block is interconnected with all necessary hydraulic elements.

An intermediate flange is preferably used to connect the two cylindrical housings in such a way that they rotate in unison and to increase the stability of the assembly unit. In addition, an intermediate flange offers very good conditions for the installation of a pressure reservoir.

In a preferred embodiment of such a stabilizer, the hydraulic and control part is connected to the coupling pressure space of the switchable coupling via an internal delivery line and to the coupling spring space of the switchable coupling via an external suction line. Furthermore, the delivery line is connected to an electric manometric switch and the suction line to a pressure reservoir, and the delivery line and the suction line are in connection via a bridge line, wherein an electromagnetically switchable (2/2-way valve, which is designed such that it is closed in the energized position and open in the non-energized position, is arranged in the bridge line.

Furthermore, the pressure reservoir may be designed as a single-acting piston-and-cylinder unit with a reservoir cylinder, a reservoir piston and a reservoir compression spring loading the reservoir piston, and the reservoir cylinder and the reservoir piston may be arranged in the intermediate flange and the reservoir compression spring with its reservoir spring space may be arranged in the first stabilizer part. It is very advantageous to design the pressure reservoir as a single-acting piston-and-cylinder unit, because the radial installation space can thus be kept small.

It is generally advantageous if the hydraulic and control part is directed coaxially to the mechanical part of the switchable coupling, because the radial free space necessary for the twisting motion on the vehicle can thus be kept small. Only a very small installation space is thus needed in both the radial direction and the axial direction if a valve block that can be interconnected is designed.

The present invention shall be explained in more detail on the basis of an exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a perspective view showing a two-part and switchable stabilizer;

FIG. 2 is a sectional view of the switchable coupling of the stabilizer; and

FIG. 3 is a second sectional view of the switchable coupling, rotated by 90° with respect to the showing of FIG. 2.

### DESCRIPTION OF THE PREFERRED EMBODIMENT

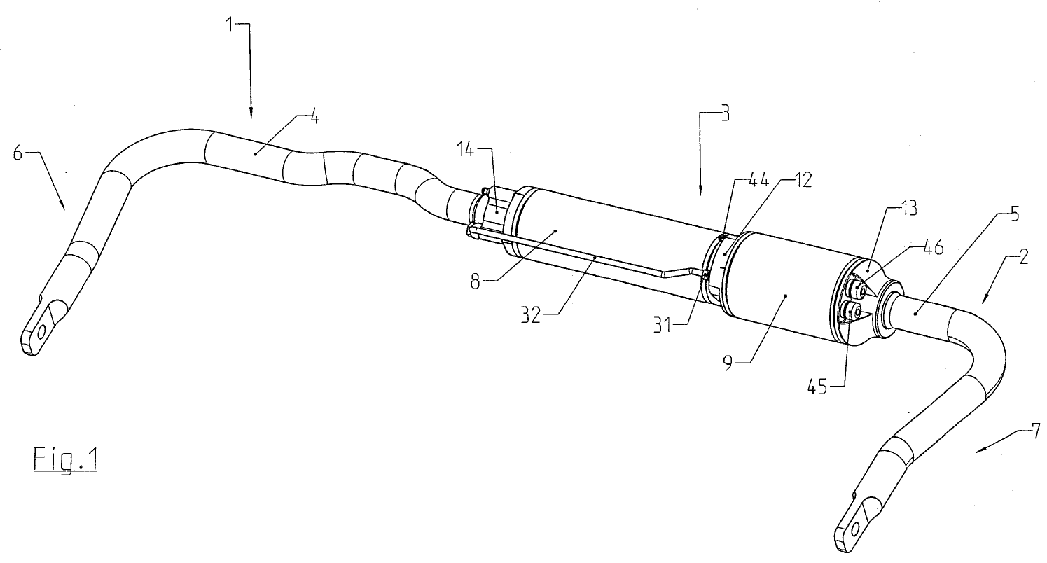

Referring to the drawings in particular, according to the embodiment of FIG. 1, the switchable stabilizer comprises a first stabilizer part 1 and a second stabilizer part 2, both of which are connected to one another by a switchable coupling 3. Both stabilizer parts 1, 2 are attached to the vehicle body via a stabilizer bearing 4, 5 and to the wheels of the vehicle via a rocker pendulum 6, 7. The switchable coupling 3 comprises a mechanical part 8 and a hydraulic and control part 9, wherein the mechanical part 8 connects the two stabilizer parts 1, 2 to one another in one end position and separates them for a limited torsion angle in the other end position.

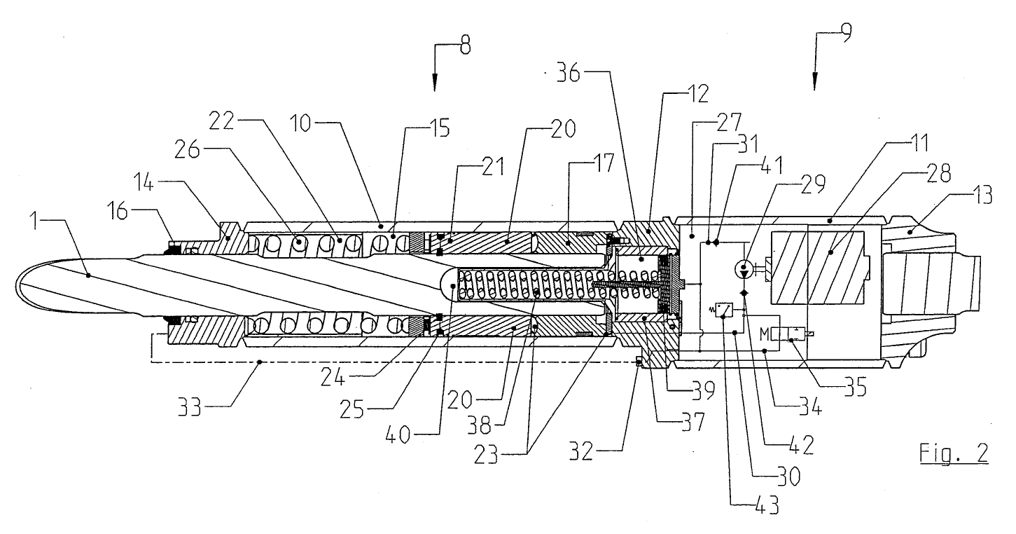

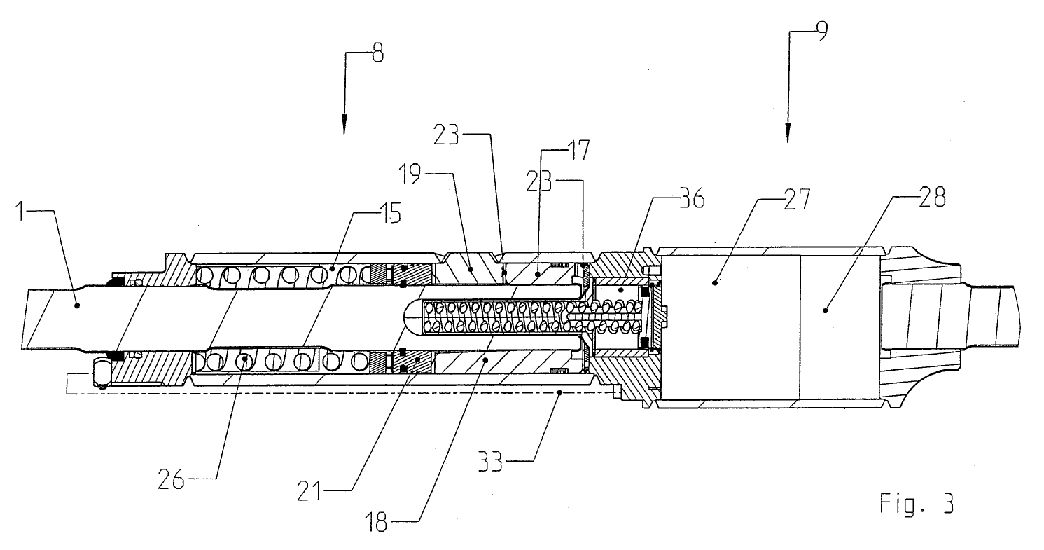

As is apparent especially from FIGS. 2 and 3, the mechanical part 8 of the switchable coupling 3 has a cylindrical housing 10 and the hydraulic and control part 9 a cylindrical housing 11, the two being connected to one another via an intermediate flange 12 in such a way that they rotate in unison. The cylindrical housings 10, 11, designed as one-part housings in this manner, are in turn connected to the second stabilizer part 2 via a housing flange 13 in such a way that they rotate in unison. The cylindrical housing 10 of the mechanical part 8 is equipped on the side of the first stabilizer part 1 with the bearing flange 14, through which the end of the first stabilizer part 1 is inserted into the interior of the mechanical part 8. The first stabilizer part 1 and the cylindrical housing 10 are radially spaced apart from one another here such that an annular space 15 is obtained over the entire axial length of the cylindrical housing 10. This annular space 15 is hydraulically sealed towards the outside via a sealing element 16 in the area of the bearing flange 14.

The first stabilizer part 1 carries at its free end a force transmission part 17, which is connected to the first stabilizer part 1 in such a way that they rotate in unison and which is designed such that it slides in relation to the inner wall of the cylindrical housing 10 and which supports itself and the first stabilizer part 1 axially at the intermediate flange 12. According to FIG. 3, this force transmission part 17 has an axially extending toothed element 18 with preferably conical tooth profiles. As is also shown in FIG. 3, a toothed element 19 fitting thereto is inserted in the axial area of this toothed part 18 in the cylindrical housing 10 in such a way that it rotates in unison. The two toothed elements 18, 19 form two opposite free spaces between them, which mesh with two correspondingly adapted locking elements 20 of an axially displaceable locking piston 21. This locking piston 21 is designed for this purpose in such a way that it slides in relation to the first stabilizer part 1 and in relation to the inner wall of the cylindrical housing 10 and axially and in such a limited manner that a coupling spring space 22 is formed between the locking piston 21 and the bearing flange 14, on the one hand, and a coupling pressure space 23 is formed between the locking piston 21 and the intermediate flange 12, on the other hand. For the hydraulic separation from the coupling pressure space 23 and from the coupling spring space 22, the locking piston 21 has an inner sealing element 24 against the first stabilizer part 1 and an outer sealing element 25 against the cylindrical housing 10. A coupling compression spring 26, which is supported on the bearing flange 14 and loads the locking piston 21 in the direction of the force transmission part 17, is inserted into the coupling spring space 22. In the opposite direction, the locking piston 21 is loaded by the force of a hydraulic pressure in the coupling pressure space 23. Both toothed elements 18, 19 of the force transmission part 17 and of the cylindrical housing 10 as well as the two locking elements 20 of the locking piston 21 are coordinated with one another such that they couple under the force of the coupling compression spring 26 and establish a clearance-free connection between the first stabilizer part 1 and the cylindrical housing 10 and uncouple over a limited axial path under the load of the hydraulic pressure in the coupling pressure space 23 and thus release a limited torsion angle between the first stabilizer part 1 and the cylindrical housing 10.

The hydraulic and control part 9 comprises essentially a hydraulic valve block 27, which is arranged within the cylindrical housing 11 in spatial vicinity of the mechanical part 8 and is interconnected to corresponding hydraulic elements. These hydraulic elements form a closed hydraulic circuit for driving the mechanical part 8 of the switchable coupling 3.

Thus, an electric motor 28, which is coupled with a pump 29, belongs to this hydraulic circuit. This pump 29 is connected to the coupling pressure space 23 of the hydraulic coupling 3 via a delivery line 30 led through the intermediate flange 12, and it is connected to the coupling spring space 22 of the switchable coupling 3 via a suction line 31, a suction connection 32 and a suction line 33 located on the outside. The delivery line 30 and the suction line 31 are connected for this by a bridge line 34, in which an electromagnetically switchable 2/2-way valve 35 is arranged. The suction line 30 is connected, furthermore, to a pressure reservoir 36, which is formed from a reservoir cylinder 37 and a reservoir piston 39 loaded by a reservoir compression spring 38. The reservoir cylinder 37 and the reservoir piston 39 are arranged in space in the intermediate flange 12, while the reservoir compression spring 38 extends into an axially extending reservoir spring space 40. This reservoir spring space 40 is milled into the first stabilizer part 1. A nonreturn valve 41, which cannot be unblocked and opens in the direction of the pump 29, is located in the suction line 31, whereas a nonreturn valve 42, which cannot be unblocked and closes in the direction of the pump 29, is arranged in the delivery line 30. The delivery line 30 is, furthermore, connected to an electric manometric switch 43.

The hydraulic and control part 9 has, furthermore, as is shown in FIG. 1, a hydraulic filling supply 44 on the intermediate flange 12 and two electric supplies 45 and 46 for the 2/2-way valve 35 and for the electric motor 28 on the housing flange 13.

To establish the readiness to operate, the entire hydraulic system including the coupling spring space 22, the coupling pressure space 23 and the pressure reservoir 36 is filled with a sufficient quantity of compressed oil via the filling supply 44, so that a pressure sufficient for the actuation of the switchable coupling 3 is present.

The electric motor 28 is switched off and the 2/2-way valve 35 is maintained in the non-energized state under normal road conditions. The 2/2-way valve 35 thus assumes its open position, in which it lets the medium through, so that the delivery line 30 and the suction line 31 are in connection with one another via the bridge line 34 and via the 2/2-way valve 35. The delivery line 30 and the suction line 31 consequently carry equal pressure, which propagates into the coupling pressure space 23 and the coupling spring space 22 and loads the locking piston 21 with equal pressure on both sides. Because of the equal areas, the hydraulic forces offset each other at the locking piston 21 and the force of the coupling compression spring 26 thus displaces the locking piston 21 in the direction of the force transmission part 17. The conical locking elements 20 now enter the space between the toothed element 18 of the first stabilizer part 1 and the toothed element 19 of the cylindrical housing 10 until the locking elements 20 and the toothed elements 18, 19 with their lateral conical surfaces are in contact with one another without clearance. The switchable coupling 3 is locked in this state and the two stabilizer parts 1 and 2 thus connected act as a one-part stabilizer. The force of the coupling compression spring 26 and the conical surfaces of the toothed elements 18, 19 and of the locking elements 20 are coordinated now with one another such that the force of the coupling compression spring 26 exceeds the axially acting torsional forces of the switchable coupling 3 and maintains the closed state of the switchable coupling 3 over the entire loading width.

The spring rate of the stabilizer parts 1 and 2 coupled with one another is no longer sufficient under abnormal road conditions, for example, off road, to compensate the rolling motions of the wheels. To obtain a greater torsion angle of the two stabilizer parts 1, 2, a central control signal is triggered, which energizes the 2/2-way valve 35 and the electric motor 28. The 2/2-way valve 35 is adjusted as a result into its blocked position, while the electric motor 28 starts running and drives the pump 29. The pump 29 now draws compressed oil out via the internal suction line 31 and the external suction line 33 from the coupling spring space 22 and delivers it via the internal delivery line 30 into the coupling pressure space 23. A pressure that is higher than the pressure in the coupling spring space 22 will thus become built up in the coupling pressure space 23. The differential pressure acts on the locking piston 21 and generates a force that counteracts the force of the coupling compression spring 26 and displaces the locking piston 21 in the direction of the bearing flange 14 into an end position. The locking of the switchable coupling 3 is abolished as a result, and the free ends of the toothed elements 18, 19, on the one hand, and of the locking elements 20, on the other hand, remain axially overlapped. However, a predetermined radial pivoting angle becomes established between the toothed elements 18, 19 and the locking elements 20 due to the conicity of the lateral conical surfaces. A predetermined pressure, which propagates via the internal delivery line 30 and actuates the manometric switch 43, becomes established in the coupling pressure space 23 in this end position of the locking piston 21. The electric motor 28 is switched off with this control signal, and the pressure conditions remain unchanged in the delivery line 30 and hence in the coupling pressure space 23 as well as in the suction line 31 and hence in the coupling spring space 22. The opened position of the switchable coupling 3 is thus maintained.

As the road conditions improve, a central control signal is again sent to the hydraulic and control part 9, as a consequence of which the energization of the 2/2-way valve 35 is abolished. The 2/2-way valve 35 is displaced again into its opened position as a result, so that the delivery line 30 and the suction line 31 are again connected and a pressure equalization is established at the locking piston 21. The locking piston is displaced because of the force of the coupling compression spring 26 and locks the switchable coupling.

Possible changes in volume, which may occur due to temperature changes or losses from leakage, are compensated by the pressure reservoir 36 loaded by the reservoir compression spring 38.

Damage in the electric control part of the hydraulic and control part 9 causes that the 2/2-valve 35 will always assume the position in which it lets medium through, so that at least the locked functional area of the switchable coupling 3 is maintained.

While a specific embodiment of the invention has been shown and described in detail to illustrate the application of the principles of the invention, it will be understood that the invention may be embodied otherwise without departing from such principles.

1. A switchable stabilizer for a motor vehicle, the switchable stabilizer comprising:
a first stabilizer part;
a second stabilizer part;
a switchable coupling, said first stabilizer part and said second stabilizer part being connected to one another via said switchable coupling;
a hydraulic and control part with a hydraulic system, wherein said switchable coupling is designed as a single-acting piston-and-cylinder unit and is connected to said hydraulic and control part and said hydraulic system of said hydraulic and control part forms a closed circuit with the piston-and-cylinder unit of said switchable coupling unit.

2. A switchable stabilizer in accordance with claim 1, wherein:
said hydraulic and control part is connected to a coupling pressure space of said switchable coupling via a delivery line and to a coupling spring space of said switchable coupling via a suction line;
said delivery line is connected to an electric manometric switch and said suction line is connected to a pressure reservoir;
said delivery line and said suction line are in connection via a bridge line; and
an electromagnetically switchable 2/2-way valve, which is designed such that it is closed in the energized position and open in the non-energized position, is arranged in said bridge line.

3. A switchable stabilizer for a motor vehicle, comprising:
a first stabilizer part;
a second stabilizer part;
a switchable coupling, said first stabilizer part and said second stabilizer part being connected to one another via said switchable coupling;
a hydraulic and control part with a hydraulic system wherein said switchable coupling comprising a single-acting piston-and-cylinder unit and is connected to said hydraulic and control part, said hydraulic and control part being integrated in a cylindrical housing of said switchable coupling.

4. A switchable stabilizer in accordance with claim 3, wherein said hydraulic and control part is directed coaxially to said switchable coupling and comprises a cylindrical housing and a valve block arranged in said cylindrical housing, wherein said cylindrical housing of said hydraulic and control part is connected to said cylindrical housing of said switchable coupling in such a way that it rotates in unison, and said valve block is interconnected with all necessary hydraulic elements.

5. A switchable stabilizer in accordance with claim 4, wherein an intermediate flange is used for connecting said two cylindrical housings in such a way that they rotate in unison.

6. A switchable stabilizer in accordance with claim 3, wherein:
said hydraulic and control part is connected to a coupling pressure space of said switchable coupling via an internal delivery line and to a coupling spring space of said switchable coupling via an external suction line;
said delivery line is connected to an electric manometric switch and said suction line to a pressure reservoir;
said delivery line and said suction line are in connection via a bridge line; and
an electromagnetically switchable 2/2-way valve, which is designed such that it is closed in the energized position and open in the non-energized position, is arranged in said bridge line.

7. A switchable stabilizer in accordance with claim 6, wherein said pressure reservoir comprises a single-acting piston-and-cylinder unit with a reservoir cylinder, a reservoir piston and a reservoir compression spring loading said reservoir piston, and said reservoir cylinder and said reservoir piston are arranged in said intermediate flange and said reservoir compression spring with its said reservoir spring space is arranged in said first stabilizer part.
